(19) United States
(12) Patent Application Publication
(10) Pub. No.: US 2009/0178217 A1
(43) Pub. Date: Jul. 16, 2009

(54) Apparatus and Method for Encouraging Hand Washing

(76) Inventors: Michael J. Reiter, San Diego, CA (US); Thomas Alan Arnold, Poway, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/352,589

(22) Filed: Jan. 12, 2009

Related U.S. Application Data
(60) Provisional application No. 61/010,705, filed on Jan. 11, 2008.
(60) Provisional application No. 61/188,655, filed on Aug. 12, 2008.

(51) Int. Cl. B08B 3/00

(52) U.S. Cl. 15/104.92

(57) ABSTRACT

A device to encourage hand washing which provides visual feedback to a user who can control a video game or other visual feedback device while washing their hands. The device features at least one controller configured to operate when wet or continually doused with water while the user is washing their hands. The user may view a video or other means for visual interaction while washing their hands, and control a portion of the display with the controller. A video game or the like may thus be played by washing their hands thereby providing user encouragement to wash their hands. The controller may be employed with movement to provide a dermabrasive action against the palm of the user and with a surrounding skirt which is adapted to clean the back side of their hand while operating the controller.

This application claims priority from U.S. Provisional Application No. 61/188,655 filed on Aug. 12, 2008 and U.S. Provisional Application No. 61/010,705 filed on Jan. 11, 2008 both of which are incorporated herein in their entirety by reference.

### BACKGROUND OF THE INVENTION

1. Field of Invention

The present invention relates generally to hygiene and hand washing. More particularly, the device and method herein disclosed and described relate to an apparatus and a method used for easily, quickly and effectively teaching children and young adults to properly wash their hands, and encourage ongoing hand washing through the playing of games while the user is concurrently properly washing their hands.

2. Description of Related Art

The present invention is concerned with the problem of teaching and encouraging children and adults, proper techniques and time frames for hand washing. While hand washing is a simple habit which will help keep a person healthy, the benefits of good hand washing only occur when a person actually washes their hands frequently and does so in a proper fashion.

Hand washing, when exercised regularly and using a proper technique, is one of the best ways for a person to avoid illness. While being a simple habit, which requires only soap and warm water, hand washing is rarely done properly or frequently enough by most people to reap the full benefits.

On any given day people accumulate germs on their hands from a variety of sources. This can include many sources of germs such as direct contact with other people, contaminated surfaces such as tables, escalator handholds, foods, even animals such as the family dog or cat. Subsequent to these contacts, if people don't wash their hands frequently and use the correct technique, they can easily infect themselves by touching their eyes, nose, mouth, or food. Further, failure to wash their hands will render a person a carrier who spreads germs to others by touching those people directly or by touching surfaces which they contact such as doorknobs.

As a consequence of inadequate hand hygiene, especially in children, infectious diseases are commonly spread from one person to another. Everything from the common cold and flu to gastrointestinal disorders, such as infectious diarrhea, are easily communicated from one person to the next.

Inadequate hand hygiene and improper hand washing techniques also contribute to food-related illnesses such as, salmonella and E. coli infection. In fact, according to the Centers for Disease Control and Prevention (CDC), as many as 76 million Americans get a food-borne illness each year. Of these, about 5,000 die as a result of their illness. Others experience the annoying signs and symptoms of nausea, vomiting and diarrhea. This chilling statistic could easily be reduced if food handlers and people eating prepared food, washed their hands with proper technique and for sufficient time periods.

Good hand-washing techniques, if taught to children, will be a habit they can maintain the rest of their adult lives. However, many parents are not present in the home for sufficient time to render education on proper technique. Further, many parents themselves do not have knowledge of the proper hand washing techniques and time durations required for proper hand hygiene.

Further, many children resist instruction on proper hand washing technique, or actually employing such techniques for the proper duration of time, finding it boring or time consuming.

This is a sorry predicament since hand washing is especially important for children who attend child care and schools. Children younger than 3 years, in child care, are at greater risk of respiratory and gastrointestinal diseases, which can easily spread to family members and others in the community. Consequently, to protect children's health, it is important that both parents and child care providers promote sound hygiene, including frequent hand washing several times a day—not just before meals.

As such, there is an unmet need for a device and method that will enable parents and child caretakers to actually get the children to wash their hands frequently and properly. Such a device and method should be employable by young children without the need for adult supervision and provide a means of continued encouragement for such young user to wash their hands properly and for a sufficient duration. Still further, such a device should be fun and emulate activities in which modern children already participate for fun, such as video games to encourage constant and repeated use. Finally, such a device should be adaptable to encourage use frequently by older children and adults so that frequent hand washing for sufficient durations becomes commonplace, and an activity which is actually enjoyed.

In this respect, before explaining at least one embodiment of the device and method herein in detail it is to be understood that the invention is not limited in its application to the details of construction and to the arrangement, of the components set forth in the following description or illustrated in the drawings. The invention is capable of other embodiments and of being practiced and carried out in various ways which will become obvious to those skilled in the art who read this specification. Also, it is to be understood that the phraseology and terminology employed herein are for the purpose of description and should not be regarded as limiting of the invention in any fashion.

As such, those skilled in the art will appreciate that the conception upon which this disclosure is based, may readily be utilized as a basis for designing of other structures, methods and systems for carrying out the several purposes of the present invention to instruct and encourage the art of hand washing. It is important, therefore, that the claims be regarded as including any such equivalent construction insofar as they do not depart from the spirit and scope of the present invention.

### SUMMARY OF THE INVENTION

The disclosed device and method herein provide both a device, and a method for the encouragement of proper hand washing. The invention employs both a process and a mechanism which makes hand washing both entertaining and consistently effective. By employing conventional electronic game elements and input devices adapted to provide proper hand washing to the user while they are playing, the device provides entertainment in a way that insures the recommended duration and method of hand washing is achieved by the user. However, the device removes the need for any actual skill on the user's part for doing so, while encouraging use for sufficient durations to disinfect hands by making the act play time.

In this fashion, the device and method herein reduces the amount of dirt spread about the home by hand contact, but more importantly prevents the ingestion and transmission of harmful germs.

In emulating a conventional action or electronic toy, the device employs an input device in the form of a controller which is adapted to operate inside the wet confines of a conventional household sink. The input device comes in the form easily employed by a child or adult alike, in that, it operates much the same as a game joystick or a game controller. While the device will operate with one joystick-like or other game controller, hand washing is an act that employs both hands and consequently the game controller provides two hand-manipulatable controllers adapted for input in the wet environment of a sink, both of which are manipulated to play the game or otherwise operate the device.

Each controller, which controls a video or other game adapted to the use of a hand controller, is structurally adapted to thoroughly clean all surfaces of the user's hand while being used to control one or a plurality of operably engaged game devices or entertaining devices, such as a doll, and using software adapted to the task. In a simple mode of the device, which provides a novel component to encourage hand washing, the controller will employ one game controller such as a joystick, or other controller that may be gripped by a hand to control a game or entertaining remote device.

Manipulation by the user of the game controller, and optionally the base for the controller, in the electronic mode of the device, provides input signals to a microprocessor unit, such as a computer or electronic gaming device. Of course, a pneumatic or other mode of the device may be employed to control a game or other entertaining component and would still be in the scope of the device herein.

In the electronic mode of the device, a video display operatively engaged to the computer, provides a visual interface means for the user to operate the game, or other video being displayed, by their movement and manipulation of the controller in the sink. The controller if elongated sufficiently to grip, for instance a joystick, may be adapted for slight moving frictional engagement with the palm of the users hand such as rotating or vibrating it while in the palm of the user's hand during use to thereby enhance cleaning.

During manipulation of the game controller, to operate the game or other software-provided video being displayed on the video display, the user is concurrently washing their hands. The software which the controller operates, will interface with the signals generated by the user manipulation of the controller, with the video game or other entertaining or educational material depicted on the video display. Movement by the user of the game controller and/or its control components causes interaction with the displayed video. For instance the controller may control the movement of an iconic curser on the video display which moves about a computer generated game or entertaining video on the display. The software would be adapted to have the user operate the controller at least for sufficient time to properly wash their hands. Optionally but preferred, the software running on the computer or game processor will have modes of operation where the software actually elicits movements by the user's hands, which combined with the actions of the controller and hand engagement, which will enable a more thorough washing of the hands.

In use in this mode of the device, the joystick or other lever or button components of the controller are also adapted to clean the palm-side of the hands and fingers. While a significant hand-cleaning improvement is provided just by the user gripping a control component during use, in another preferred mode of the device, a surrounding skirt is also provided. The skirt, during movements of a control component, such as a lever or joystick, during use by the hands by the user to control the game, concurrently provides a means to scrub the back side of the hand and fingers which currently is provided by bristles or other projections extending toward the axis of the joystick. During use, the bristles will wash and scrub the back side of the hands and fingers of the user, while concurrently the gripped control portion is washing the palm side of the hand and fingers. In this fashion, the bristles will clean the back side of the hand and the lever, or joystick, or control ball, or other hand-gripped component of the controller, will wash the palm side of the hand.

In another preferred mode of the device, which provides a water reservoir, the skirt may also be formed as a frusto conical interior cover to the gripped-control portion of the controller, such as the depicted joystick. The skirt, as depicted, curves at a terminal end to form a back wall which engages the base of the gripped-control such as the depicted joystick. A cavity is thus formed between the back wall and the covered gripped-control portion of the controller, as well as a reservoir in the central portion of the cover.

This cone shaped skirt will employ and angle between 50 to 70 degrees which provides for easy egress and ingress of the user's hand to manipulate the joystick or other gripped-control component, or remove their hand from the device. With a portion of the cone covering the gripped-controller in an angled fashion, an increased cleaning of the palm side of the hand is provided by the constant slipping or upward translation out of the user's hand by the cone cover when it is wet with soapy water. Experimentation has found that a 60 degree angle away from the axis at the base of the contact with the gripped-controller works best. This is because if the angle is too narrow then the cone will not easily squirt up out of the hand when squeezed, but if the angle is too broad then the cone will not feel comfortable within the user's hand.

Further, the diameter of the interior portion of the cone surrounding the gripped-controller component must be sized so the hand can easily grasp it. For small children this may be reduced, whereas, with adults or adolescents it will increase to adapt to their larger hand size.

The surface of the cone forming the skirt surrounding the gripped-controller to define the cavity, is populated with a means for scrubbing the palm side of the hand. Currently this means for scrubbing employs a plurality of small scrubbing bristles, however, other scrubbing projections may be employed. The cone surface surrounding the gripped-controller also forms a depression providing a water reservoir and drain holes which allow water to flow from the faucet into the depression. From the depression, water communicates through the drain holes onto the hand of the user.

The skirt in either mode of the device may be static and thereby clean the exterior of the hands when the hands move the gripped-controller, or they may rotate to provide additional inputs to the game for the user to control the video on the video display. If employed in a rotational fashion as an input, the skirt is a rotation cam. The bio mechanics of the human hand, when it grasps a cone, creates a twisting motion of that cone. The rotation is approximately a quarter-rotation during the translation of the cone. The rotation cam-pin of the skirt works with the follower-track on the frame or base to accentuate this natural motion. A return spring assures the mechanism returns to its start position when the user's grip is released.

The base provides a mount for the gripped-controllers, and if employed, the skirts and cone portions. It is of substantially rigid construction to provide stability and mounting for the other primary components. In a preferred mode of the device, the axis of the two gripped-controllers and surrounding components are angled away from the centerline of the base at an included angle of about 30-degrees. While the device yields a vast improvement to hand cleaning without this angled engagement on the base, it has been found the angled engagement improves the ergonomics of holding the control with both hands and to allow them to straddle the faucet within the sink. Thus, the angled engagement from the base is preferred to allow a straddling of the faucet at this angled position by both hands which improves the flow of water to each hand and allows the controller to more easily fit within the sink.

Activation of the device can be provided by any number of means of activation as would occur to those skilled in the art. A first means of activation would employ a soap dispenser, which when pressed to dispense soap, will signal the computer to energize the video display and controller for a defined period of time to wash a user's hands. Or, gripping either gripped-controller, may also initiate a signal or an accelerometer or similar motion detector mounted on the base, will continuously monitor the controller for movement and initiate a signal to the computer to energize the components and to run the appropriate software program for the user for the appropriate duration to wash their hands properly.

The gripped-controllers if used without the conical skirt, may vibrate or spin in the user's hands during use to better scrub the palms and fingers. A soft covering adapted to cleaning skin would cover the exterior of the gripped-controller.

Also, in a particularly preferred mode of the device, software running on the computer, game console, or other micro processing unit adapted to the task, may be adapted to elicit movements of the users hands during use, to provide a better washing of the hands. This may be done by providing the video to the video display for which the user employs to controller and gripped-controllers to manipulate a curser or other graphic depiction on the video display. Making the displayed game or track in particular fashions can induce movements from the user which will better provide cleaning of the hand surfaces.

The soap dispenser will dispense any commercially available hand cleaning agent and can be any soap dispenser adapted to the task. The device may be provided with a housing or switch to initiate the signal to the computer to start a session if the initiation signal is provided by soap dispensing.

In use, the user would dispense soap to the hands with the dispenser and then grab the gripped-controllers on the controller. The computer sensing either the soap or movement of the controller will move from a software induced sleep mode, to an active mode where signals are sent to the video display to energize and the computer awaits input from the controller caused by user movement.

The user gripping the gripped-controller will then place the controller under the running faucet and wet their hands directly or through filling the reservoir if the conical cover is employed. Thereafter, the computer will run gaming or other software which requires user manipulation of the controller and the gripped-controllers to play. The controller, as noted, may have an accelerometer or other motion sensor to provide input to the computer to be used in the game. The gripped-controllers will provide conventional signals as are employed from conventional gripped-controllers.

All electronic parts in the controller are sealed to prevent water intrusions using conventional means. Electrical power for the controller will be provided by conventional batteries or low power transformer, as is the case also with the computer and video display. Communication of signals from the controller to the computer may be wired but would be preferably by wireless means to alleviate the need for wires around a sink. The video display and soap dish activation switch may be hard wired or also may be wireless.

It is thus an object of this invention to provide a device which cleans the hands of the user while they are using the device to play or interface with a computer generated video display.

It is a further object of this invention to provide such a device which will self time and can also provide software to elicit movements by the user's hands to better clean them during use.

These and further objectives of this invention will be brought out in the following part of the specification, wherein detailed description is provided for the purpose of fully disclosing the invention without placing limitations thereon.

With respect to the description provided herein, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the descriptions provided herein are considered as illustrative only of the principles of the invention.

Further, since numerous modifications and changes will readily occur to those skilled in the art, upon reading this disclosure, it is not desired to limit the invention to the exact construction and operation shown and described, and accordingly, all suitable modifications and equivalents which may be resorted to, are considered to be within the scope of this invention.

### BRIEF DESCRIPTION OF THE DRAWINGS

The accompanying drawings, which are incorporated in and form a part of this specification, illustrate preferred embodiments of the invention and together with the description, serve to explain the principles of this invention.

FIG. 1 shows a representation of the basic mode of the device employing a controller with gripped controller components such as joysticks, or levers, operatively engaged to interact with a visual display.

FIG. 2 depicts a mode of the device wherein a skirt surrounds a gripped controller, such as a joystick or lever, which is perpendicular to the base.

FIG. 3 is a perspective cut-away view of a mode of the gripped-controllers having a frusto conical covering over the gripped-controller extending to form a skirt which slips during use thereby providing a means to scrub the hands of the user.

FIG. 4 shows another mode of the device of FIG. 3 wherein the skirt is engaged to an electrical switch adapted to signal an input during upward slippage in the user's hand.

FIG. 5 depicts another mode of the controller similar to FIG. 4 wherein the skirt is engaged to operate a bellows on each upward translation in the user's hand.

FIG. 6 depicts a mode of the device where it is self contained and the controllers input either electronic or pneumatic signals to interact with the display which may be an electronic screen or a water based display.

FIG. 7 shows a mode of the device which provides for interaction with a three dimensional doll or plush toy or the like, through movement of the gripped-controllers.

### DETAILED DESCRIPTION OF THE PREFERRED EMBODIMENTS OF THE INVENTION

In the following description of preferred embodiments of the device and method of employment thereof, reference is made to the accompanying drawings that form a part hereof, and in which is shown by way of illustration specific embodiments in which the invention may be practiced. It is to be understood that other embodiments may be utilized and structural changes may be made without departing from the scope of the present invention and any and all changes or adaptations which may be made by those skilled in the art, are considered to be within the scope of the claimed device and method.

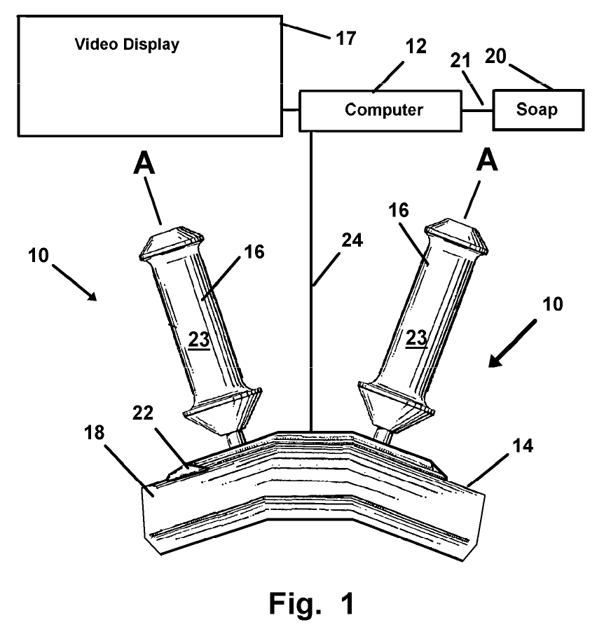

Referring now to FIGS. 1-6 wherein similar parts of the invention are identified by like reference numerals, there is seen in FIG. 1, a representative view of the components of the disclosed device 10. The device 10 employs operatively engaged components which will be familiar to youthful users in that they emulate the play of conventional video or interactive games where the user inputs signals from a controller 14 and therefor encourages use of the device 10 amongst the young.

In the electronic mode of inputting signals from the user, a computer 12 is provided along with software adapted to receive input signals from the manipulations of a controller 14 and allow the user to interface with the video depictions on a video display 17 operatively communicating with the computer 12. As noted, the controller 14 has all electronics sealed in a manner which will protect them from operating in the wet environment of a sink.

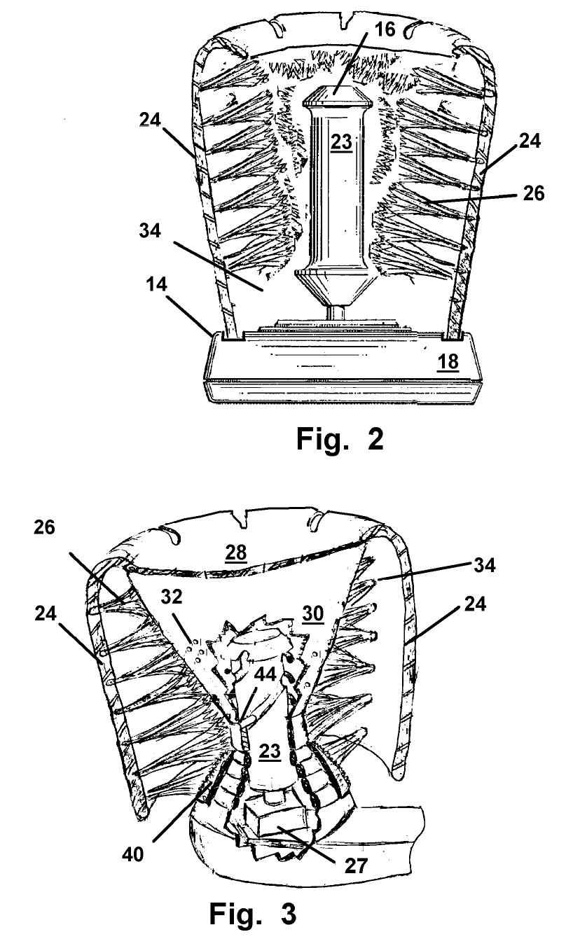

In use, to encourage hand washing by an individual, and facilitate a better outcome, a means for gripped control is shown as at least one gripped-controller 16 such as a joystick, which is operatively engaged to the base 18 of the controller 14. While a joystick is shown in many of the drawings as a favored mode of a gripped-controller 16, those skilled in the art will realize that any controller adapted for gripping by the user's hand and to work in an aquatic environment, which will allow the user to interact with a display component, such as a member or lever, or simply the skirt 24 shown in FIGS. 2-6 will work. As such, it is anticipated that other control inputs may be employed that will allow the user to clean their hands during use, and any such controllers as would occur to those skilled in the art, which may be gripped by a user washing their hands and concurrently controlling or interfacing with a viewable display, is within the scope of this patent. Further, while the device 10 will work with one gripped-control such as a gripped-controller 16 in a reasonable fashion, users conventionally wash both hands at once consequently two gripped-controllers 16 such as joysticks 23, extending from a mount of some type such as the base 18, are the preferred mode of the device 10.

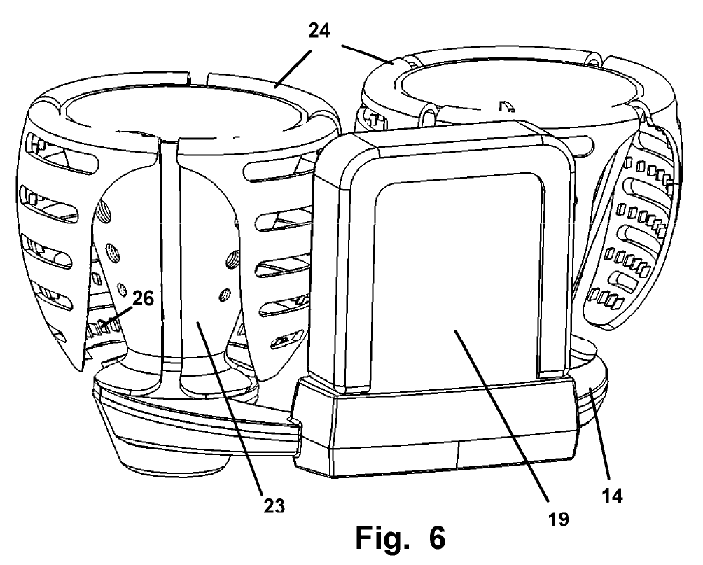

Still further, the invention employs a gripped-controller 16 for the user to interact with a display screen. The display screen may be a video display 17 such as an LCD screen, or might be a small water filled or aquatic display 19 as in FIG. 6, or it may be any means for visual interaction with a gripped-controller 16 operated by a user where hand actions of the user on the gripped-controller 16 will cause a reaction on the display screen. Consequently, any display which will interact with a gripped-controller 16 while the user is washing their hands using the gripped-controller, as would occur to those skilled in the art, is anticipated within the scope of this patent.

In a first preferred mode of the device 10 shown in FIG. 1, electronic means is employed to encourage a user to wash their hands and to increase the efficiency of the act. In this mode, a gripped-controller 16 is provide by the controller 14 along with water from a faucet (not shown) and soap from a soap dispenser 20. A means for electronic switching of the device 10 into operational mode may be provided by a switch, proximity sensor, or in a current preferred mode, a soap dispenser 20 having an electronic signaling means to communicate a signal 21 to the computer 12 that a session has begun. Thus, the first action by the user in dispensing soap from the dispenser 20 will initiate the computer to move to operational mode, energize the video display 17, and run the software for the controller 14 to operate.

The user with soap on their hands will position the controller 14 under the water flow from the faucet in a sink, whereby the hands will be wetted. Thereafter, using the gripped-controllers 16 shown as the joysticks 23 in each hand, the user inputs signals to affect the displayed video on the video display 17. A game or other means to allow user input signals from the gripped-controller is provided by the software running on the computer 12. In this electronic mode, users by their movement and manipulation of the joysticks 16 or other gripped-controller over the sink, will cause a viewable action on the display 17 which interacts with what is being displayed.

Additional input signals may be provided by a motion sensor such as an accelerometer 22 engaged to the body of the controller 14, which will sense the tilt and movement of the controller 14, and provide additional input signals which will have some interaction with the visual display to run the game or other video displayed on the video display 17. Optionally, and in a particularly preferred mode, the gripped controller 16 may be adapted to rotate or vibrate or translate in the palm of the user's hand during use to enhance cleaning. This can be done with a means to generate a movement 27 to the gripped-controllers 16 while being gripped by the user in an as-used position, such as one or a combination of, a small motor to rotate the gripped-controllers 16 or a vibration generation device being engaged to the gripped-controllers 16 or means to translate the gripped-controllers such as a solenoid. This rotation, translation, or vibration, as noted may be accomplished with simple motors, or solenoids, or vibrators in the controller 14 which are operatively engaged to the gripped controller 16. The movement thereby provided while the user holds the gripped-controller 16 provides means to scrub the palms of the user's hands and better clean and exfoliate the skin of the user thereby removing more germs and dirt and the like.

The gripped-controllers 16 and interaction by the user with the software on the computer 12 significantly enhance hand cleaning. However, in another particularly preferred mode of all embodiments of the device 10, the axis of both of the gripped-controllers 16 and any surrounding components, are angled away from the centerline of the base at an included angle “A” of about 30-degrees. This angled engagement is particularly preferred because it improves the ergonomics of holding the control 14 with both hands, and to allow users to straddle the faucet and place the device in the small confines of a sink since it shortens the overall length of the base 22 when measured end to end in a straight line.

In use, software adapted to run on the computer will intake signals generated by the user manipulation of the controller 14 and the gripped-controllers 16, and employ those signals to run or play or interface with the video game or other media depicted on the video display 17 or in the case of the device 10 in FIG. 6, the aquatic display 19. Transmission of signals from the controller 14 to the computer 12 as signified by line 24, may be by conventional wired or wireless communication using WiFi, BlueTooth, or Infrared signals communicating the user movements of the controller 14 and its components. The computer 12 would also have a timer in the software or otherwise running to end the game after sufficient time has elapsed for hand cleaning.

In another particularly preferred mode of the device 10, shown in FIG. 2, a skirt 24 is engaged to the controller 14 which is shown engaged to a gripped-controller 16 in the form of a single joystick 23 but can easily be configured with two gripped-controllers 16 as in FIG. 1, and perpendicular as in FIG. 2, or at the preferred 30 degree angle “A” of FIG. 1.

In this mode, the skirt 24 surrounds approximately half of the circumference of the gripped-controller 16. Bristles 26 provide a means to scrub the back side of the hand and fingers while the user manipulates the joystick 16 to control or play the video display 17. As in all modes, the gripped-controller 16 may rotate or vibrate or translate during use to clean the palms better and provide the means to scrub which exfoliates skin cells.

In another preferred mode of the device 10 shown in FIG. 3, additional utility is provided by a water reservoir 28 formed of a frusto conical shape. The skirt 24 may also be formed as an extension of the frusto conical interior skirt 30 which fits over the gripped-controller 16. The reservoir 28 is provided by the central section of the conical shaped portion which can collect water dispensed from a faucet for continual communication through apertures 32 to the hands of the user during use.

This cone shaped interior skirt 30 will best employ an angle between 50 to 70 degrees away from the center axis of the gripped-controller 16. A cavity 34 is formed between the interior skirt 30 portion and the skirt 24 which is accessible by the two open ends at the termination points of both skirts.

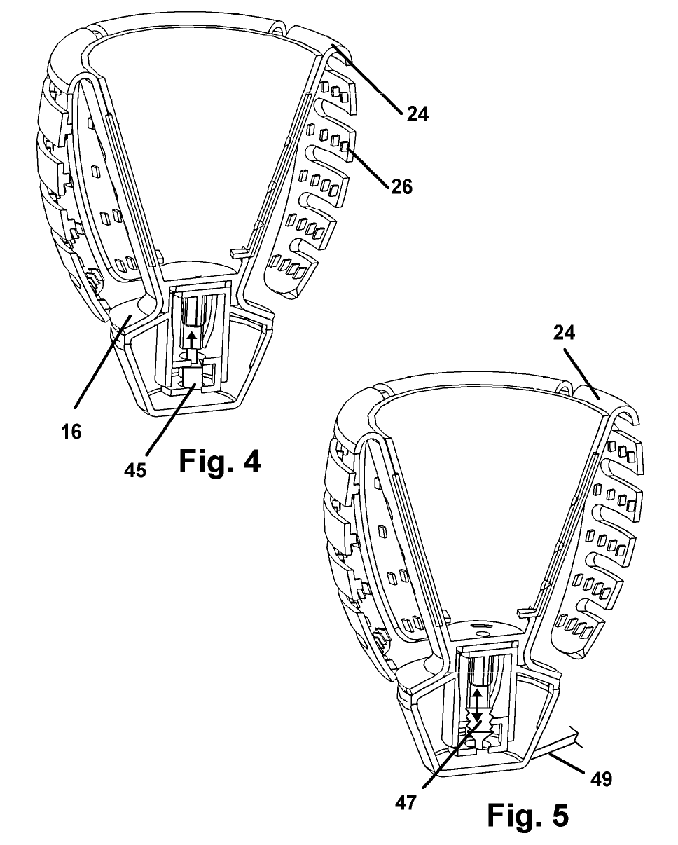

Particularly preferred in this mode is to form the interior skirt 30 portion covering the joystick 16 in an angled fashion which provides increased cleaning of the palm side of the hand as the angled sides provide a means for slipping of the interior skirt 30 upward and out of the user's hand when it is wet with soapy water. Formed of flexible material, or translatably engaged components as in FIGS. 4-5, or both, the interior skirt 30 may also have short bristles 40 extending there from or some other abrasive means to clean the palms of the hands better.

As noted, the skirt 24 may be static in mounting to the base 22 or the gripped-controller 16 and thereby clean the exterior of the hands when the hands move the gripped-controller 16, or the skirt 24 may provide another moveable input for the controller 14 by rotating in communication with electrical sensors 44 to provide additional signals to the game for the user to control the video on the video display 17.

In a method of use of the device 10 the user would dispense soap from the soap dispenser 20 to the hands and then grip the joysticks 16 on the controller 14. The computer 12 sensing either the soap dispensing from a switch or movement of the controller 14 will move from a software-induced sleep mode, to an active mode where signals are sent to the video display 17 to energize, and the computer 12 awaits input from the controller 14 caused by user movement.

The user gripping the gripped-controller 16 will then place the controller 14 under the running faucet and wet their hands directly or through filling the reservoir 28 if the conical cover having the interior skirt 30 is employed. Thereafter the computer 12 will run gaming or other software which requires user manipulation of the controller 14 and/or the gripped-controller 16 to input signals which interact with the video display 17. The controller 14 as noted may have an accelerometer 22 or other motion sensor to provide input to the computer to be used in the game. The gripped-controllers 16 during play will provide conventional signals as are employed from conventional joysticks used on computers or signals adapted to the task in a similar fashion. A timer in the computer 12 or software induced will end operation of the device 10 once a sufficient time is ascertained to have washed the user's hands.

In FIG. 4 there is shown another mode of gripped-controller 16 the device of FIG. 3 wherein the skirt 24 is engaged to an electrical switch 45 adapted to output a signal during translation of the skirt 24 from upward slippage in the user's hand. The upward movement will cause the switch 45 to output a signal in electronic mode to cause a visual reaction on the display or video display 17.

FIG. 5 depicts another mode of the gripped-controller 16 similar to that of FIG. 4 wherein the skirt 24 is engaged to translate upward during use and slippage in the palm of the user. This translation of the base of the skirt 24 serves to operate a bellows 47 during upward and downward translation caused by the user's hand. The bellows 47 will thus output a pneumatic signal through the conduit 49 which can either be used to activate some electronic signaling device for an electronic signal, or may be employed to interact with a water based aquatic display 19 shown in FIG. 6 with bubbles or movement of some aspect of the aquatic display 19.

There is depicted in FIG. 6, a mode of the device 10 where it is self contained and the controller has two gripped-controllers 16 having skirts 24 thereon and the conical slipping interior. While depicted as an aquatic mode of the device 10 the aquatic display 19 may be replaced with a video display 17 and the bellows 47 replaced with electronic inputs to form a fully portable electronic mode of the device 10. A microprocessor as a computer 12 would be mounted within the base along with batteries for power in the electronic mode. As depicted in the pneumatic mode for signaling from the gripped-controllers 16, the device will allow user interaction with the aquatic display 19 by movement of the gripped-controllers 16 which will generate pneumatic or hydraulic signals from a pumping means such as the depicted bellows 47.

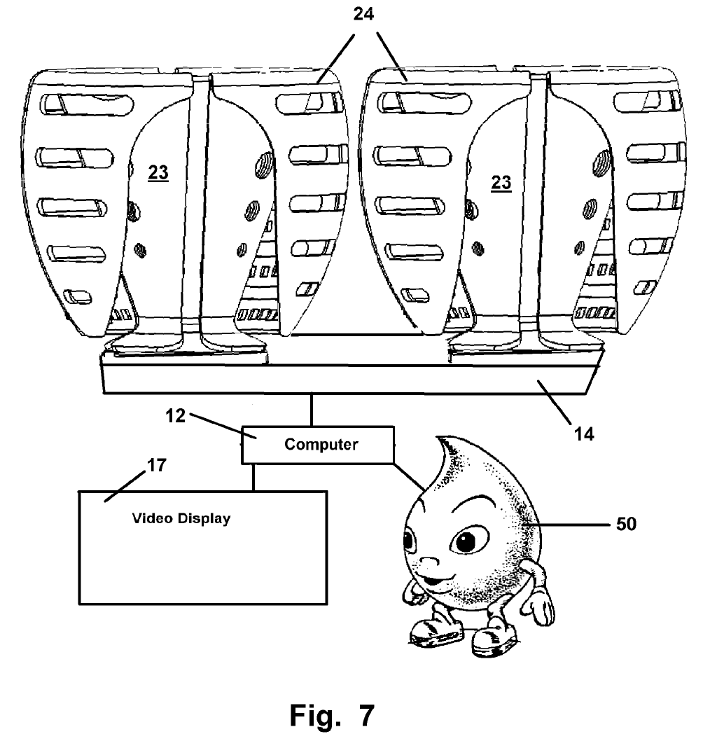

As noted above, the user action with the gripped-controllers 16 will generate a signal to allow the user to interact with a means for visual feedback or play based on their hand movement. In FIG. 7 there is shown a mode of the device 10 wherein a doll or plush toy such as a teddy bear, or other three-dimensional interactive component 50 provides the means for the user to interact with a visual feedback device by their hand movements while gripping the gripped-controllers 16. In this mode, the user manipulating one or both gripped-controllers 16 will cause the interactive component 50 to move or talk or take some other action that may be viewed and affected by the user through movement of the controller 14 and/or the gripped controllers 16. A computer 12 running software adapted to the task would be provided separately or mounted on the device 10 to allow it to plug into one or a plurality of interactive components 50. Additionally, a video display 17 may be provided as an alternative or for concurrent use with the interactive component 50.

The disclosed device employing a controller and communicating video display to encourage hand cleaning by a user as shown in the drawings and described in detail herein discloses arrangements of elements of particular construction and configuration for illustrating preferred embodiments of structure and method of operation of the present invention. As noted above, it is to be understood that elements of different construction and configuration and other arrangements thereof, other than those illustrated and described may be employed for providing an apparatus using video games and depictions controlled by a hand washing controller in accordance with the spirit of this invention, any such changes, alternations and modifications as would occur to those skilled in the art are considered to be within the scope of this invention as broadly defined in the appended claims.

What is claimed is:

1. An apparatus for hand washing comprising:
at least one controller, said controller configured to operate when wet or continually doused with water;
said controller generating a signal relative to hand movement by a user gripping said controller on a gripping surface; and
visual means for interaction, said visual means for interaction providing a visual feedback to said user relative to said signal generated by said controller, whereby said user gripping said controller in an as-used position, may concurrently wash their hand and operate said controller to interact with said visual means for interaction.

2. The apparatus for hand washing of claim 1 additionally comprising:
said signal being one of a hydraulic or a pneumatic signal generated by a means for pumping, said means for pumping in and engagement with said gripping surface; and
said visual means for interaction being a water filled cavity having glass on one side surface through which said user may view a movement of water or an object in said filled cavity caused by said signal from said controller.

3. The apparatus for handwashing of claim 1 additionally comprising:
said signal from said controller being electronic;
a microprocessor running software thereon, said microprocessor electrically engaged to receives said signal from said controller;
said visual means for interaction being a video display operatively engaged to said microprocessor;
said software displaying an interactive display on said video display; and
said visual feedback to said user provided by a portion of said interactive display reacting so said signal from said controller.

4. The apparatus for handwashing of claim 3 additionally comprising:
said interactive display being a video game.

5. The apparatus for handwashing of claim 1 additionally comprising:
said signal from said controller being electronic;
a microprocessor running software thereon, said microprocessor electrically engaged to receives said signal from said controller;
said visual means for interaction being a robotic plush toy or doll operatively engaged to said computer;
said software adapted to cause movement by said robotic plush toy or doll in a response to said signal from said controller; and
said visual feedback to said user provided by said plush toy or doll, said plush toy or doll having movements, said movements being relative to said signal from said controller.

6. The apparatus for handwashing of claim 1 additionally comprising:
a skirt, said skirt surrounding a portion of said gripping surface; and
said skirt having means to scrub said back side of said hand of said user in said as-used position.

7. The apparatus for handwashing of claim 2 additionally comprising:
a skirt, said skirt surrounding a portion of said gripping surface; and
said skirt having means to scrub said back side of said hand of said user in said as-used position.

8. The apparatus for handwashing of claim 3 additionally comprising:
a skirt, said skirt surrounding a portion of said gripping surface; and
said skirt having means to scrub said back side of said hand of said user in said as-used position.

9. The apparatus for handwashing of claim 4 additionally comprising:
a skirt, said skirt surrounding a portion of said gripping surface; and
said skirt having means to scrub said back side of said hand of said user in said as-used position.

10. The apparatus for handwashing of claim 5 additionally comprising:
a skirt, said skirt surrounding a portion of said gripping surface; and
said skirt having means to scrub said back side of said hand of said user in said as-used position.

11. The apparatus for handwashing of claim 1 additionally comprising:
means to generate a movement to said gripping surface while in said as-used position being gripped by the palm side of said user's hand; and
said movement providing an abrasive action to said palm side of said hand thereby providing means to scrub said palm side of said hand in said as used position.

12. The apparatus for handwashing of claim 6 additionally comprising:
means to generate a movement to said gripping surface while in said as-used position being gripped by the palm side of said user's hand; and
said movement providing an abrasive action to said palm side of said hand thereby providing means to scrub said palm side of said hand in said as used position.

13. The apparatus for handwashing of claim 7 additionally comprising:
means to generate a movement to said gripping surface while in said as-used position being gripped by the palm side of said user's hand; and
said movement providing an abrasive action to said palm side of said hand thereby providing means to scrub said palm side of said hand in said as used position.

14. The apparatus for handwashing of claim 8 additionally comprising:
means to generate a movement to said gripping surface while in said as-used position being gripped by the palm side of said user's hand; and
said movement providing an abrasive action to said palm side of said hand thereby providing means to scrub said palm side of said hand in said as used position.

15. The apparatus for handwashing of claim 9 additionally comprising:
means to generate a movement to said gripping surface while in said as-used position being gripped by the palm side of said user's hand; and
said movement providing an abrasive action to said palm side of said hand thereby providing means to scrub said palm side of said hand in said as used position.

16. The apparatus for handwashing of claim 10 additionally comprising:
means to generate a movement to said gripping surface while in said as-used position being gripped by the palm side of said user's hand; and
said movement providing an abrasive action to said palm side of said hand thereby providing means to scrub said palm side of said hand in said as used position.

17. The apparatus for handwashing of claim 12 additionally comprising:
said means to generate a movement being one or a combination of a motor, a vibrator, or a solenoid, thereby imparting one or a combination of movements to said gripping surface from a group of movements including rotation, vibration, and translation.

18. The apparatus for handwashing of claim 15 additionally comprising:
said means to generate a movement being one or a combination of a motor, a vibrator, or a solenoid, thereby imparting one or a combination of movements to said gripping surface from a group of movements including rotation, vibration, and translation.

19. The apparatus for handwashing of claim 16 additionally comprising:
said means to generate a movement being one or a combination of a motor, a vibrator, or a solenoid, thereby imparting one or a combination of movements to said gripping surface from a group of movements including rotation, vibration, and translation.

20. The apparatus for hand washing of claim 15 additionally comprising:
said skirt engaged to a electronic sensor;
said senor generating a second said signal relative to movements of said skirt; and
said portion of said interactive display also reacting to said second signal, whereby said user may generate both said signal and said second signal by movements of said gripping surface and said skirt respectively and receive said visual feedback from said portion of said interactive display reacting to both said signal from said controller and said second signal from said electronic sensor.
